(19) United States
(12) Patent Application Publication
(10) Pub. No.: US 2026/0128764 A1
(43) Pub. Date: May 7, 2026

(54) JOINT BEAMFORMING IN INTEGRATED SENSING AND COMMUNICATION WITH BACKSCATTERING RFID TAGS

(71) Applicant: ARIZONA BOARD OF REGENTS ON BEHALF OF ARIZONA STATE UNIVERSITY, Scottsdale, AZ (US)

(72) Inventors: Ahmed Alkhateeb, Chandler, AZ (US); Hao Luo, Tempe, AZ (US); Umut Demirhan, Tempe, AZ (US)

(73) Assignee: ARIZONA BOARD OF REGENTS ON BEHALF OF ARIZONA STATE UNIVERSITY, Scottsdale, AZ (US)

(21) Appl. No.: 19/382,619

(22) Filed: Nov. 7, 2025

Related U.S. Application Data
(60) Provisional application No. 63/717,398, filed on Nov. 7, 2024.

(51) Int. Cl. H04B 7/0408; H04B 7/0426

(52) U.S. Cl. CPC H04B 7/0408; H04B 7/043

(57) ABSTRACT

System and method for integrating sensing and communication (ISAC) systems with backscattering radio frequency identification (RFID) tags are disclosed. An access point employs a communication beam to serve a communications device while using a sensing beam to detect an RFID tag. Under the total transmit power constraint of the system, sensing and communication beams are designed by considering tag detection and communication specifications. Zero-forcing is used to design the beamforming vectors, and a convex optimization problem is solved to determine the power allocation between sensing and communication. Minimizing the total transmit power and satisfying tag detection and communication specifications are accomplished by joint beamforming design. To resolve this, we re-formulate the non-convex constraints into convex second-order cone constraints. The simulation results demonstrate that, under different communication SINR specifications, joint beamforming optimization outperforms the zero-forcing-based method in terms of achievable detection distance, offering a promising approach for the ISAC-backscattering systems.

### CROSS-REFERENCE TO RELATED APPLICATIONS

This application claims the benefit of U.S. Provisional Patent Application Ser. No. 63/717,398, filed Nov. 7, 2024, the disclosure of which is incorporated herein by reference in its entirety.

### STATEMENT OF GOVERNMENT SUPPORT

This invention was made with government support under grant number 2229530 awarded by the National Science Foundation. The government has certain rights in the invention.

### FIELD OF THE DISCLOSURE

The present disclosure is directed to integrated sensing and communication (ISAC), and specifically to ISAC systems with backscattering radio frequency identification (RFID) tags.

### BACKGROUND

In ISAC, for example, radar sensor data and communications data use the same spectrum and signals that are transmitted and received by the same hardware. ISAC may, for example, enable the sharing of sites, spectrum, and hardware, and the reuse of waveforms and signals. ISAC may be used for inventory management in warehouses or retail stores, where low-cost passive RFID tags replace barcodes. With ISAC, systems can leverage sensing signals to track goods by detecting RFID tags, while simultaneously transmitting signals to communication targets such as, for example, wireless surveillance cameras or mobile devices, in a cooperative manner. RFID tags have limited range due to the absence of a built-in power source. This limitation could be mitigated, for instance, by employing multiple input multiple output (MIMO) beamforming at the RFID reader. The mutual interference between the sensing and communication signals may significantly impact the reading reliability of the RFID tags. What is needed is joint sensing and communication beamforming for an ISAC system with backscattering RFID tags.

### SUMMARY

Systems and methods in accordance with embodiments of the present disclosure include joint beamforming in an ISAC system with backscattering RFID tags. The system and method optimize the ISAC-backscattering beamforming to meet detect tags and communication signal-to-inference-plus-noise ratio (SINR) metrics under a transmit power constraint of joint design of sensing and communication beams while minimizing the transmit power. The non-convex constraints are transformed into second-order cone constraints that can be solved with convex optimization tools. In some configurations, zero-forcing is used to design beamforming vectors and determine transmit power allocation between sensing and communication beams. The achievable detection distance of the tag can be improved as the number of antennas increases.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for an access point to detect and read a tag while communicating electronically with a communications device. The method includes determining a tolerance for interference between signals associated with detecting the tag and communicating electronically. The method also includes determining power constraints for detecting the tag and for communicating electronically, selecting and executing a process based on the tolerance, determining a phase of beamforming vectors based on the process, determining a power allocation based on the process and the power constraints, determining a waveform based on the phase and the power allocation, transmitting communications signals and tag sensing signals on the waveform to enable communications with the communications device while detecting the tag, and receiving the tag sensing signals, and detecting the tag based on the tolerance. Other embodiments of this aspect include corresponding computer systems, apparatus, and computer programs recorded on one or more computer storage devices, each configured to perform the actions of the methods.

Implementations may include one or more of the following features. The access point may include a transmitter antenna and a receiver antenna. The method may include separating a received signal from a transmitted signal. The tag and the communications device each may include an antenna. The tag scatters signals by modulating the tag sensing waveform. The method may include using the scattered signals to determine a position. The communications device receives the signals from the access point and the scattered signals from the tag. The communications and tag sensing waveform satisfy the power constraints. A channel between the access point and the tag is reciprocal. A received signal signal-to-inference-plus-noise ratio (SINR) at the tag is based on allocated power for sensing and communications, and normalized sensing and communications beamforming vectors. A received SINR at the access point is based on allocated power for sensing and communications, and normalized sensing and communications beamforming vectors. The signal at the communications device is based on a first channel between an access point and the communications device, a second channel between the tag and the communications device, and noise at the communications device. A SINR of the communications device is based on a first channel between the access point and the communications device, a second channel between the tag and the access point, the sensing and communications beams, and the allocated power. The sensing and communications device beams that detect the tag meet specifications (1) sum of squares of the sensing and communications device beams≤a total power, (2) a device SINR for the communications device≥a communications device specification, (3) a tag SINR for the tag≥a tag specification, and (4) an access point SINR for the access point≥an access point specification. The process may include zero-forcing which may include determining the beamforming vectors based on a tag channel associated with a tag position of the tag and a communications device channel associated with a device position of the communications device, normalizing the beamforming vectors to satisfy the power constraints, and minimizing, using a convex solver, tag power and communications device power based on a tag SINR, a communications device SINR, an access point SINR, and a total power. The process may include joint beamforming which may include minimizing a sum of sensing beam and communications device beams based on a communications device SINR, a tag SINR, a receiver SINR transformed into second-order cone constraints, a sum of squares of sensing and communications device beams, and a total power. The tag may include one of a passive tag or an active tag. Implementations of the described techniques may include hardware, a method or process, or computer software on a computer-accessible medium.

One general aspect includes a computer system for an access point to detect and read a tag while communicating electronically with a communications device. The computer system also includes a hardware processor, a non-volatile storage medium storing instructions that when executed by the hardware processor perform operations. The operations may include determining a tolerance for interference between signals associated with detecting the tag and communicating electronically, determining power constraints for detecting the tag and for communicating electronically, selecting and executing a process based on the tolerance, determining a phase of beamforming vectors based on the process, determining a power allocation based on the process and the power constraints, determining a waveform based on the phase and the power allocation, transmitting communications signals and tag sensing signals on the waveform to enable communications with the communications device while detecting the tag, and receiving the tag sensing signals. The system also includes detecting the tag based on the tolerance. Other embodiments of this aspect include corresponding computer systems, apparatus, and computer programs recorded on one or more computer storage devices, each configured to perform the actions of the methods.

One general aspect includes a computer program product for an access point to detect and read a tag while communicating electronically with a communications device. The computer program product also includes determining a tolerance for interference between signals associated with detecting the tag and communicating electronically. The product also includes determining power constraints for detecting the tag and for communicating electronically. The product also includes selecting and executing a process based on the tolerance. The product also includes determining a phase of beamforming vectors based on the process. The product also includes determining a power allocation based on the process and the power constraints. The product also includes determining a waveform based on the phase and the power allocation. The product also includes transmitting communications signals and tag sensing signals on the waveform to enable communications with the communications device while detecting the tag, and receiving the tag sensing signals, and detecting the tag based on the tolerance. Other embodiments of this aspect include corresponding computer systems, apparatus, and computer programs recorded on one or more computer storage devices, each configured to perform the actions of the methods.

It is to be understood that both the foregoing general description and the following detailed description provides examples that are not restrictive of the present teachings, as claimed.

### BRIEF DESCRIPTION OF THE DRAWINGS

The accompanying drawings, which are incorporated in and constitute a part of this specification, illustrate aspects of the present teachings and together with the description, serve to explain the principles of the present teachings.

FIG. 1 is a pictorial diagram of a MIMO ISAC system in accordance with embodiments of the present disclosure system, where an access point transmits sensing and communication waveforms to communicate with a communications device while detecting a passive RFID tag, in the context of RFID-aided inventory management and surveillance systems within a warehouse;

FIGS. 2A and 2B are graphical illustrations of the achievable detection distance of different tag directions, where the communications device's position remains fixed at (5/\sqrt{2}, 5/\sqrt{2}), under low and high communications device SINR specifications, respectively;

FIG. 3 is a graphical illustration of the cumulative distribution function (CDF) of the coverage ratio across different communications device positions, where the detection coverage is computed as the average ratio of the achievable detection distance to the upper bound across different angles, where the number of antennas is 4, and SINRᵤ is 0 dB;

FIG. 4 is a graphical illustration of the total allocated power with different tag directions, where the communications device's position is at (5/\sqrt{2}, 5/\sqrt{2}), the tag's distance is 6 meters, the number of antennas is 4, and SINRᵤ is 0 dB;

FIGS. 5A and 5B are graphical illustrations of beamforming patterns resulting from executing joint beamforming optimization and zero-forcing, where the number of antennas is 8, the directions of the tag and the communications device are 90° and 135°, respectively; and

FIG. 6 is a method in accordance with embodiments of the present disclosure.

It should be noted that some details of the figures have been simplified and are drawn to facilitate understanding.

### DESCRIPTION

Reference will now be made in detail to the present teachings, examples of which are illustrated in the accompanying drawings. In the drawings, like reference numerals have been used throughout to designate identical elements. In the following description, reference is made to the accompanying drawings that form a part thereof, and in which is shown by way of illustration specific examples of practicing the present teachings.

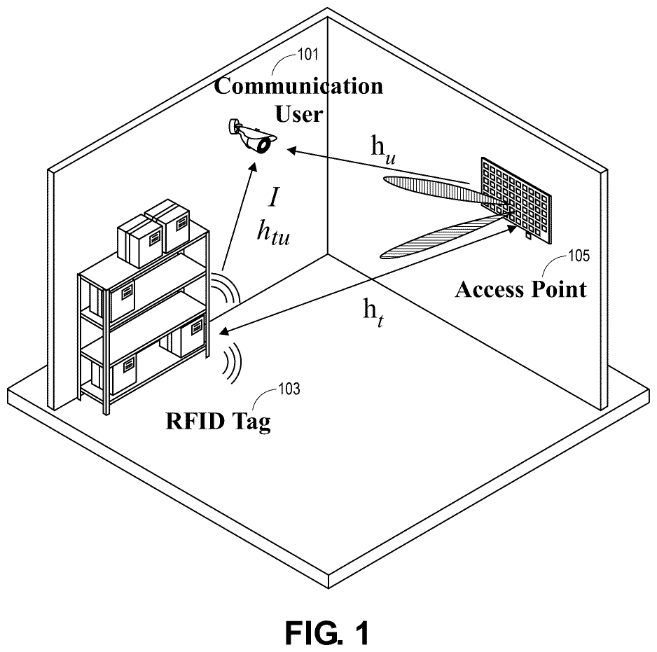

Referring to FIG. 1, a MIMO ISAC system may include an access point 105, T passive RFID tags 103, and U communication users 101. In this system, the access point 105 transmits a joint communication and RFID sensing waveform to serve the users while simultaneously interrogating the tags in the environment. The tags may be interrogated one by one. Each tag scatters back the stored information by modulating the incident sensing signal. The backscattered signal received by the access point can be further processed for sensing purposes, such as identification, positioning, and tracking. The access point 105 may be equipped with Mₜ transmitter and Mᵣ receiver antennas. Each of the tags 103 and the users 101 may be equipped with a single antenna. The access point 105 may separate the received signal from the transmitted signal, with no consideration for signal leakage.

In some configurations, an integrated sensing and backscatter communication system includes a base station that employs transmit beamforming to communicate with a communications device while broadcasting sensing signals to detect an RFID tag. In systems where there is different power allocation between sensing and communication, the sensitivities of both the tag and the reader are concerns.

Continuing to refer to FIG. 1, the transmit signal at the access point 105 is defined as the sum of the communication and sensing signals with corresponding beamforming. The transmit signal is x∈ [symbol] , which can be formulated as

$$x = {f}_{t}^{( s )} {s}_{t}^{( s )} + {\sum }_{u = 1}^{U} {f}_{u}^{( c )} {s}_{u}^{( c )} , \qquad ( 1 )$$

where

$${s}_{t}^{( s )} ∈ C$$

is the RFID sensing signal for the t^{th} tag, e.g., a continuous wave, and

$${s}_{u}^{( c )} ∈ C$$

is the data for the communications device 101. The signals are unit average energy, i.e.,

$$E [ {\vert {s}_{t}^{( s )} \vert}^{2} ] = E [ {\vert {s}_{u}^{( c )} \vert}^{2} ] = 1. {f}_{t}^{( s )} ∈ and {f}_{u}^{( c )} ∈$$

are sensing and communication beamforming vectors, respectively. The beamforming vectors satisfy the transmit power constraint, i.e.,

$${\vert {f}_{t}^{( s )} \vert}^{2} + {\sum }_{u = 1}^{U} {\vert {f}_{u}^{( c )} \vert}^{2} \leq P ,$$

where P is the total transmit power.

The RFID tag 103 performs backscatter modulation using the received signals. The channel between the access point 105 and the t^{th} tag is gₜ∈ [symbol] . The received signal at the t^{th} tag is

$${y}_{t} = {g}_{t}^{H} x + {n}_{t} = {g}_{t}^{H} {f}_{t}^{( s )} {s}_{t}^{( s )} + {\sum }_{u = 1}^{U} {g}_{t}^{H} {f}_{u}^{( c )} {s}_{u}^{( c )} + {n}_{t} \qquad ( 2 )$$

where

$${n}_{t} ∼ 𝒞𝒩 ( 0 , {σ}_{t}^{2} )$$

is the receiver noise at the RFID tag 103. Then, the RFID tag 103 scatters back the signal that contains the stored data by modulating the impinging signal. The backscatter-modulated signal can be expressed as

$${r}_{t} = \sqrt{{η}_{t}} {y}_{t} {d}_{t} \qquad ( 3 )$$

where ηₜ is the backscatter modulation efficiency, and dₜ is the encoded tag's data with E[|dₜ|²]=1. The signal modulated by the RFID tag 103 is received at the access point 105. In some configurations, the channel between the access point 105 and the RFID tag 103 is reciprocal. The received signal at the access point 105 is

$${y}_{r} = {w}_{t}^{H} {g}_{t} {r}_{t} + {w}_{t}^{H} {n}_{r} = {w}_{t}^{H} {g}_{t} \sqrt{{η}_{t}} {d}_{t} ( {g}_{t}^{H} {f}_{t}^{( s )} {s}_{t}^{( s )} + {\sum }_{u = 1}^{U} {g}_{t}^{H} {f}_{u}^{( c )} {s}_{u}^{( c )} + {n}_{t} ) + {w}_{t}^{H} {n}_{r} \qquad ( 4 )$$

where wₜ∈ [symbol] is the combining vector used by the access point 105, and

$${n}_{r} ∼ 𝒞𝒩 ( 0 , {σ}_{r}^{2} I )$$

is the receiver noise vector. The received signal at the RFID tag 103 is as in Eq. (2), and the corresponding received SINR is

$$\begin{matrix}{SINR}_{t}^{( t )} ( {f}_{t}^{( s )} , \{ {f}_{u}^{( c )} \} ) = \frac{E [ {\vert {g}_{t}^{H} {f}_{t}^{( s )} {s}_{t}^{( s )} \vert}^{2} ]}{E [ {\sum }_{u = 1}^{U} {\vert {g}_{t}^{H} {f}_{u}^{( c )} {s}_{u}^{( c )} \vert}^{2} ] + E [ {\vert {n}_{t} \vert}^{2} ]} \\ = \frac{{\vert {g}_{t}^{H} {f}_{t}^{( s )} \vert}^{2}}{{\sum }_{u = 1}^{U} {\vert {g}_{t}^{H} {f}_{u}^{( c )} \vert}^{2} + {σ}_{t}^{2}} \\ = \frac{{P}_{t}^{( s )} {\vert {g}_{t}^{H} \overline{{f}_{t}^{( s )}} \vert}^{2}}{{\sum }_{u = 1}^{U} {P}_{u}^{( c )} {\vert {g}_{t}^{H} \overline{{f}_{u}^{( c )}} \vert}^{2} + {σ}_{t}^{2}}\end{matrix} \qquad ( 5 )$$

where

$${P}_{t}^{( s )} and {P}_{u}^{( c )}$$

are the allocated power for sensing and communication, respectively.

$$\overline{{f}_{t}^{( s )}} and \overline{{f}_{u}^{( c )}}$$

are the normalized sensing and communication beamforming vectors respectively, i.e.,

$$\overline{{f}_{t}^{( s )}} = {f}_{{t}^{( s )}} / ‖ {f}_{t}^{( s )} ‖ , \overline{{f}_{u}^{( c )}} = {f}_{{u}^{( c )}} / ‖ {f}_{u}^{( c )} ‖ .$$

Based on Eq. (4), the received SINR at the access point 105 is

$${SINR}_{t}^{( r )} ( {f}_{t}^{( s )} , \{ {f}_{u}^{( c )} \} ) = \frac{{η}_{t} {\vert {w}_{t}^{H} {g}_{t} \vert}^{2} {\vert {g}_{t}^{H} {f}_{t}^{( s )} \vert}^{2}}{{\sum }_{u = 1}^{U} {η}_{t} {\vert {w}_{t}^{H} {g}_{f} \vert}^{2} {\vert {g}_{t}^{H} {f}_{u}^{( c )} \vert}^{2} + {η}_{t} {σ}_{t}^{2} {\vert {w}_{t}^{H} {g}_{t} \vert}^{2} + {σ}_{r}^{2}} = \frac{{η}_{t} {\vert {w}_{t}^{H} {g}_{f} \vert}^{2} {P}_{t}^{( s )} {\vert {g}_{t}^{H} \overline{{f}_{t}^{( s )}} \vert}^{2}}{{\sum }_{u = 1}^{U} {η}_{t} {\vert {w}_{t}^{H} {g}_{t} \vert}^{2} {P}_{u}^{( c )} {\vert {g}_{t}^{H} \overline{{f}_{u}^{( c )}} \vert}^{2} + {η}_{t} {σ}_{t}^{2} {\vert {w}_{t}^{H} {g}_{t} \vert}^{2} + {σ}_{r}^{2}} . \qquad ( 6 )$$

To detect the tag, the SINRs at the RFID tag 103 and the access point 105 meet their respective sensitivity constraints.

For communications, the communications device 101 receives the transmitted signal from the access point 105 and the backscattered signal from the RFID tag 103. The received signal at the u^{th} user is

$${y}_{u} = {h}_{u}^{H} x + {h}_{t , u} {r}_{t} + {n}_{u} = {h}_{u}^{H} {f}_{u}^{( c )} {s}_{u}^{( c )} + {\sum }_{l = 1 , l \neq u}^{U} {h}_{u}^{H} {f}_{l}^{( c )} {s}_{l}^{( c )} + {h}_{u}^{H} {f}_{t}^{( s )} {s}_{t}^{( s )} + {h}_{t , u} \sqrt{{η}_{t}} {d}_{t} ( {g}_{t}^{H} {f}_{t}^{( s )} {s}_{t}^{( s )} + {\sum }_{u = 1}^{U} {g}_{t}^{H} {f}_{u}^{( c )} {s}_{u}^{( c )} + {n}_{t} ) + {n}_{u} \qquad ( 7 )$$

where hᵤ∈ [symbol] is the channel between the access point and the u^{th} user, h_{t,u}∈C is the channel between the t^{th} tag and the u^{th} user, and

$${n}_{u} ∼ ( 0 , {σ}_{u}^{2} )$$

is the receiver noise at the communications device 101. The received SINR at the communications device 101 is

$${SINR}_{t , u}^{( c )} ( {f}_{t}^{( s )} , \{ {f}_{u}^{( c )} \} ) = \frac{{\vert {h}_{u}^{H} {f}_{u}^{( c )} \vert}^{2}}{\begin{matrix}{\sum }_{l \neq u}^{U} {\vert {h}_{u}^{H} {f}_{l}^{( c )} \vert}^{2} + {\vert {h}_{u}^{H} {f}_{t}^{( s )} \vert}^{2} + \\ {η}_{t} {\vert {h}_{t , u} \vert}^{2} ( {\vert {g}_{t}^{H} {f}_{t}^{( s )} \vert}^{2} + {\sum }_{u = 1}^{U} {\vert {g}_{t}^{H} {f}_{u}^{( c )} \vert}^{2} + {σ}_{t}^{2} ) + {σ}_{u}^{2}\end{matrix}} = \frac{{P}_{u}^{( c )} {\vert {h}_{u}^{H} \overline{{f}_{u}^{( c )}} \vert}^{2}}{\begin{matrix}{\sum }_{l \neq u}^{U} {P}_{l}^{( c )} {\vert {h}_{u}^{H} \overline{{f}_{l}^{( d )}} \vert}^{2} + {P}_{t}^{( s )} {\vert {h}_{u}^{H} \overline{{f}_{t}^{( s )}} \vert}^{2} + \\ {η}_{t} {\vert {h}_{t , u} \vert}^{2} ( {P}_{t}^{( s )} \vert {g}_{t}^{H} \overline{{f}_{t}^{( s )}} \vert + {\sum }_{u = 1}^{U} {P}_{u}^{( c )} \vert {g}_{t}^{H} \overline{{f}_{u}^{( c )}} \vert + {σ}_{t}^{2} ) + {σ}_{u}^{2}\end{matrix}} . \qquad ( 8 )$$

Joint sensing and communication beamforming codebooks can scan the environment to interrogate the RFID tags while meeting the SINR requirements of the users.

$$ℱ = \{ {( {f}_{n}^{( s )} , \{ {f}_{n , u}^{( c )} \} )}_{n = 1}^{N} \}$$

denotes the joint sensing and communication codebook, with cardinality | [symbol] |=N. The codebook design problem can be formulated as

$${max}_{ℱ} {\sum }_{t = 1}^{T} {I}_{t}^{( t )} {I}_{t}^{( r )} \qquad ( 9 a )$$

$$s . t . {I}_{t}^{( t )} = ( {max}_{( {f}_{n}^{( s )} , \{ {f}_{n , u}^{( c )} \} ) ∈ ℱ} {SINR}_{t}^{( t )} ( {f}_{n}^{( s )} , \{ {f}_{n , u}^{( c )} \} ) \geq {γ}_{t} ) , \qquad ( 9 b )$$

$${I}_{t}^{( r )} = ( {max}_{( {f}_{n}^{( s )} , \{ {f}_{n , u}^{( c )} \} ) ∈ ℱ} {SINR}_{t}^{( r )} ( {f}_{n}^{( s )} , \{ {f}_{n , u}^{( c )} \} ) \geq {γ}_{r} ) , \qquad ( 9 c )$$

$${SINR}_{u}^{( c )} ( {f}_{n}^{( s )} , \{ {f}_{n , u}^{( c )} \} ) \geq {γ}_{u} , ∀ u , n , \qquad ( 9 d )$$

$${\vert {f}_{n}^{( s )} \vert}^{2} + {\sum }_{u = 1}^{U} {\vert {f}_{n , u}^{( t )} \vert}^{2} \leq P , ∀ n , \qquad ( 9 e )$$

where [symbol] (⋅) is an indicator function.

$${I}_{t}^{( t )} and {I}_{t}^{( r )}$$

are indicator variables corresponding to the tag's sensitivity γₜ and the reader's sensitivity γᵣ. The objective is to maximize the number of tags that are successfully interrogated during the beam scanning. Eqs. (9b) and (9c) determine whether the tag will be read by the access point, taking into account both the tag's sensitivity γₜ and the reader's sensitivity γᵣ. Eq. (9d) guarantees that the user SINR requirements γᵤ are satisfied. Eq. (9e) aims to ensure that each codeword meets the total transmit power constraint. In some configurations, the communication channels are known to the access point 105.

In some configurations, zero-forcing can be used to design the beamforming vectors, and optimize the transmit power allocation between sensing and communication. A beamforming vector includes two components, phase and power. Phase is the transmission direction of the signal, and can be referred to as a normalized beamforming vector. For the zero-forcing based approach, the phase and power are designed separately. Based on the communications device channel and tag channel, zero-forcing is used to design the phase, ensuring that interference is eliminated, and the beamforming vector is normalized. An optimization problem for power allocation, subject to SINR and total power constraints, is performed based on the normalized beamforming vector.

In the single-tag scenario, i.e., T=1, the objective is to design a sensing beam

$${f}_{t}^{( s )}$$

and communication beams

$$\{ {f}_{u}^{( c )} \}$$

to achieve tag interrogation while satisfying the SINR requirements of the users. The tag's channel gₜ is known by the access point. The codebook design problem in Eqs. (9a)-(9e) can be stated as:

$$find ( {f}_{t}^{( s )} , \{ {f}_{u}^{( c )} \} ) \qquad ( 10 a )$$

$$s . t . {SINR}_{t}^{( t )} ( {f}_{t}^{( s )} , \{ {f}_{u}^{( c )} \} ) \geq {γ}_{t} , \qquad ( 10 b )$$

$${SINR}_{t}^{( r )} ( {f}_{t}^{( s )} , \{ {f}_{u}^{( c )} \} ) \geq {γ}_{r} , \qquad ( 10 c )$$

$${SINR}_{u}^{( c )} ( {f}_{t}^{( s )} , \{ {f}_{u}^{( c )} \} ) \geq {γ}_{u} , ∀ u , \qquad ( 10 d )$$

$${\vert {f}_{t}^{( s )} \vert}^{2} + {\sum }_{u = 1}^{U} {\vert {f}_{u}^{( c )} \vert}^{2} \leq P . \qquad ( 10 e )$$

Zero-forcing may be used to design the beamforming vectors, and the transmit power allocation may be optimized between sensing and communication. The tag's channel may be projected onto the null-space of the user's channel, and vice versa. H=[gₜ, h₁, . . . , h_{U}]∈ [symbol] includes the channels of the tag and the users. The zero-forcing beamforming vectors are

$$[ , , … , ] = {H ( {H}^{H} H )}^{- 1} \qquad ( 11 )$$

The beamforming vectors may be normalized to satisfy the total power constraint, i.e.,

$${f}_{t}^{( s )} = \sqrt{{P}_{t}^{( s )}} ( / ‖ ‖ ) , {f}_{{t}^{( c )}} = \sqrt{{P}_{t}^{( c )}} ( / ‖ ‖ ) ,$$

∀u. The feasibility-check problem in Eqs. (10a)-(10e) may have multiple solutions, one of which uses minimal power. In some configurations, the objective may be power minimization, and

$${min}_{{P}_{t}^{( s )} , \{ {P}_{u}^{( c )} \}} {P}_{t}^{( s )} + {\sum }_{u = 1}^{U} {P}_{u}^{( c )} \qquad ( 12 a )$$

$$\begin{matrix}s . t . & {SINR}_{t}^{( t )} ( {f}_{t}^{( s )} , \{ {f}_{u}^{( c )} \} ) \geq {γ}_{t}\end{matrix} , \qquad ( 12 b )$$

$${SINR}_{t}^{( r )} ( {f}_{t}^{( s )} , \{ {f}_{u}^{( c )} \} ) \geq {γ}_{r} , \qquad ( 12 c )$$

$${SINR}_{u}^{( c )} ( {f}_{t}^{( s )} , \{ {f}_{u}^{( c )} \} ) \geq {γ}_{u} , ∀ u , \qquad ( 12 d )$$

$${P}_{t}^{( s )} + {\sum }_{u = 1}^{U} {P}_{u}^{( c )} \leq P . \qquad ( 12 e )$$

The beamforming vectors have been determined by zero-forcing, a linear programming problem. A closed-form solution to this problem may be based on jointly optimizing the beamforming and the power allocation for sensing and communication.

The joint beamforming optimization problem is

$${min}_{{f}_{t}^{( s )} , \{ {f}_{u}^{( c )} \}} {\vert {f}_{t}^{( s )} \vert}^{2} + {\sum }_{u = 1}^{U} {\vert {f}_{u}^{( c )} \vert}^{2} \qquad ( 13 a )$$

$$\begin{matrix}s . t . & {SINR}_{t}^{( t )} ( {f}_{t}^{( s )} , \{ {f}_{u}^{( c )} \} ) \geq {γ}_{t}\end{matrix} , \qquad ( 13 b )$$

$${SINR}_{t}^{( r )} ( {f}_{t}^{( s )} , \{ {f}_{u}^{( c )} \} ) \geq {γ}_{r} , \qquad ( 13 c )$$

$${SINR}_{u}^{( c )} ( {f}_{t}^{( s )} , \{ {f}_{u}^{( c )} \} ) \geq {γ}_{u} , ∀ u , \qquad ( 13 d )$$

$${\vert {f}_{t}^{( s )} \vert}^{2} + {\sum }_{u = 1}^{U} {\vert {f}_{u}^{( c )} \vert}^{2} \leq P \qquad ( 13 e )$$

The optimization variables in the SINR constraints are in fractional forms, and the problem in Eqs. (13a)-(13e) is non-convex. The SINR constraints may be transformed into second-order cone constraints, which are convex. The user's SINR constraint in Eq. (17b) is

$${\frac{1}{{γ}_{u}} {\vert {h}_{u}^{H} {f}_{u}^{( c )} \vert}^{2} \geq {\sum }_{l \neq u}^{U} {\vert {h}_{u}^{H} {f}_{l}^{( c )} \vert}^{2} + \vert {h}_{u}^{H} {f}_{t}^{( s )} \vert}^{2} + {η}_{t} {\vert {h}_{t , u} \vert}^{2} ( {\vert {g}_{t}^{H} {f}_{t}^{( s )} \vert}^{2} + {\sum }_{u = 1}^{U} {\vert {g}_{t}^{H} {f}_{u}^{( c )} \vert}^{2} + {σ}_{t}^{2} ) + {σ}_{u}^{2} . \qquad ( 14 )$$

The absolute value on the left-hand side of Eq. (14) is a non-linear function. Arbitrary phase rotation can be added to the expression in an absolute without affecting the value, i.e.,

$$\vert {h}_{u}^{H} {f}_{u}^{( c )} \vert = \vert {h}_{u}^{H} {f}_{u}^{( c )} {e}^{j θ} \vert .$$

Without loss of optimality, a phase rotation e^{jθ} may be added such that

$${h}_{u}^{H} {f}_{u}^{( c )}$$

becomes real and positive, i.e.,

$$\vert {h}_{u}^{H} {f}_{u}^{( c )} \vert = Re \{ {h}_{u}^{H} {f}_{u}^{( c )} \} \qquad ( 15 )$$

The optimal beamforming vector and the associated phase rotation are shown. By taking the square root of both sides in Eq. (14), the SINR constraint of the user may be cast in the second-order cone form:

$$\sqrt{\frac{1}{{γ}_{u}}} Re \{ {h}_{u}^{H} {f}_{u}^{( c )} \} \geq {( {\sum }_{l \neq u}^{U} {\vert {h}_{u}^{H} {f}_{l}^{( c )} \vert}^{2} + {\vert {h}_{u}^{H} {f}_{t}^{( s )} \vert}^{2} + {η}_{t} {\vert {h}_{t , u} \vert}^{2} ( {\vert {g}_{t}^{H} {f}_{t}^{( s )} \vert}^{2} + {\sum }_{u = 1}^{U} {\vert {g}_{t}^{H} {f}_{u}^{( c )} \vert}^{2} + {σ}_{t}^{2} ) + {σ}_{u}^{2} )}^{\frac{1}{2}} \qquad ( 16 )$$

The sensitivity constraints in Eqs. (13c) and (13d) can be re-written:

$$\begin{matrix} & \sqrt{\frac{1}{{γ}_{t}}} Re \{ {g}_{t}^{H} {f}_{t}^{( s )} \} \geq ‖ \begin{matrix}{g}_{t}^{H} {f}_{1}^{( c )} \\ ⋮ \\ {g}_{t}^{H} {f}_{U}^{( c )} \\ {σ}_{t}\end{matrix} ‖\end{matrix} \qquad ( 17 )$$

$$\sqrt{\frac{η}{{γ}_{r}}} \vert {w}^{H} {g}_{t} \vert Re \{ {g}_{t}^{H} {f}_{t}^{( s )} \} \geq ‖ \begin{matrix}\sqrt{η} {w}^{H} {g}_{t} {g}_{t}^{H} {f}_{1}^{( c )} \\ ⋮ \\ \sqrt{η} {w}^{H} {g}_{t} {g}_{t}^{H} {f}_{U}^{( c )} \\ \sqrt{η} {w}^{H} {g}_{t} {σ}_{t} \\ {σ}_{r}\end{matrix} ‖ \qquad ( 18 )$$

The SINR constraints in Eqs. (16)-(18) are equivalent to Eqs. (13b)-(13d). By adding phase rotation Eq. (15), each beamforming vector may be associated with a single phase rotation. The constraints in Eqs. (17) and (18) may result in adding different phase shifts to the sensing beamforming vector fₜ^{(s)}. Single phase rotation may be sufficient because one of the constraints may dominate the tag interrogation. The problem in Eqs. (13a)-(13e) becomes a convex second-order cone programming, which can be solved with convex solvers.

The codebook design problem for the multiple-tag scenario may be addressed by changing the codebook design problem in Eqs. (9a)-(9e) by dividing the region of interest into sectors and designing dedicated sensing and communication beams for each sector. The beamforming design problem may be solved based on generalized Benders decomposition, which can be iteratively applied to each sector to obtain a full codebook.

A region of interest may be divided into equal-sized sectors based on angles relative to the access point. Dedicated RFID sensing and communication beams may be designed for each sector. The region of interest may be a semi-circle area with a radius R in front of the access point. The value of R may be determined by the maximal interrogation distance that the system can achieve. The maximal interrogation distance may be found by placing a tag at different ranges and angles and determining if beamforming vectors may be designed to interrogate the tag. Each sector may be defined by an interval of angles [Θₘᵢₙ, Θₘₐₓ] and a range interval [0, R]. The beamforming design problem may maximize the area coverage for tag interrogation while satisfying the communication users' requirements as follows:

$${max}_{{f}^{( s )} , \{ {f}_{u}^{( c )} \}} {\int }_{0}^{R} {\int }_{{Θ}_{min}}^{{Θ}_{max}} {y}_{r , θ}^{( t )} {y}_{r , θ}^{( r )} d θ dr \qquad ( 19 a )$$

$$\begin{matrix}s . t . & {y}_{r , θ}^{( t )} = ( {SINR}_{r , θ}^{( t )} ( {f}^{( s )} , \{ {f}_{u}^{( c )} \} ) \geq {γ}_{t} )\end{matrix} , \qquad ( 19 b )$$

$${y}_{r , θ}^{( r )} = ( {SINR}_{r , θ}^{( r )} ( {f}^{( s )} , \{ {f}_{u}^{( c )} \} ) \geq {γ}_{r} ) , \qquad ( 19 c )$$

$${\int }_{0}^{R} {\int }_{{Θ}_{min}}^{{Θ}_{max}} ( {SINR}_{r , θ , u}^{( c )} ( {f}^{( s )} , \{ {f}_{u}^{( c )} \} ) \geq {γ}_{u} ) d θ d r = R ( {Θ}_{max} - {Θ}_{min} ) , ∀ u , \qquad ( 19 d )$$

$${\vert {f}^{( s )} \vert}^{2} + {\sum }_{u = 1}^{U} {\vert {[ {F}^{( c )} ]}_{: , u} \vert}^{2} \leq P , \qquad ( 19 e )$$

The subscript t of the SINR is replaced with r and θ, indicating the potential position of the tag at the specified distance and angle. The sector may be discretized by sampling grid points. Each grid point may be represented in polar coordinates, and the set of grid points [symbol] can be expressed as

$$𝒢 = \{ ( {r}_{m} , {θ}_{n} ) : {r}_{m} ∈ R , {θ}_{n} ∈ ϑ \} , \qquad ( 20 a )$$

$$ℛ = \{ {r}_{m} ∈ R : {r}_{m} = {r}_{m - 1} + Δ r , 0 \leq {r}_{m} \leq R \} , \qquad ( 20 b )$$

$$ϑ = \{ {θ}_{n} ∈ R : {θ}_{n} = {θ}_{n - 1} + Δ θ , {Θ}_{min} \leq {θ}_{n} \leq {Θ}_{max} \} \qquad ( 20 c )$$

where Δr and Δθ are the interval between adjacent grid points in radial and angular dimensions. Indicator variables y∈ [symbol] indicate whether each grid point, i.e., potential tag position, satisfies both reader's and tag's sensitivity constraints. The problem in Eqs. (19a)-(19e) is as follows:

$${max}_{{f}^{( s )} , \{ {f}_{u}^{( c )} \} , y} {\sum }_{i = 1}^{\vert 𝒢 \vert} {y}_{i} \qquad ( 21 a )$$

$$\begin{matrix}s . t . & {SINR}_{i}^{( c )} ( {f}^{( s )} , \{ {f}_{u}^{( c )} \} ) \geq {γ}_{t} {y}_{i} , ∀ i ∈ \{ 1 … \vert 𝒢 \vert \}\end{matrix} , \qquad ( 21 b )$$

$${SINR}_{i}^{( r )} ( {f}^{( s )} , \{ {f}_{u}^{( c )} \} ) \geq {γ}_{r} {y}_{i} , ∀ i ∈ \{ 1 … \vert 𝒢 \vert \} , \qquad ( 21 c )$$

$${SINR}_{i , u}^{( u )} ( {f}^{( s )} , \{ {f}_{u}^{( c )} \} ) \geq {γ}_{u} , ∀ i ∈ \{ 1 … \vert 𝒢 \vert \} , \qquad ( 21 d )$$

$$∀ u = 1 , … , U , \qquad ( 21 e )$$

$${\vert {f}^{( s )} \vert}^{2} + {\sum }_{u = 1}^{U} {\vert {f}_{u}^{( c )} \vert}^{2} \leq P , \qquad ( 21 f )$$

$${y}_{i} ∈ \{ 0 , 1 \} , ∀ i = 1 , … , \vert 𝒢 \vert . \qquad ( 21 g )$$

Due to the (i) mixed optimization variables, i.e., binary variables y and continuous variables f^{(s)} and

$$\{ {f}_{u}^{( c )} \} ,$$

and (ii) the second-order terms in the SINR expressions, the problem in Eqs. (21a)-(21g) is a mixed integer non-linear programming (MINLP) problem. The SINR expressions in Eqs. (21a)-(21g) are non-convex. Semidefinite relaxation may be used to recast the non-convex SINR expressions into convex forms. The beamforming vectors may be redefined as matrices, i.e., F^{(s)}=f^{(s)}(f^{(s)})^{H},

$${F}_{u}^{( c )} = {{f}_{u}^{( c )} ( {f}_{u}^{( c )} )}^{H} ,$$

and the channel vectors may be rewritten as matrices, i.e.,

$${G}_{i} = {g}_{i} {g}_{i}^{H} , {H}_{u} = {h}_{u} {h}_{u}^{H} .$$

The SINR at the tag and the access point is:

$${SINR}_{i}^{( t )} ( {F}^{( s )} , \{ {F}_{u}^{( c )} \} ) = \frac{Tr ( {G}_{i} {F}^{( s )} )}{{\sum }_{u = 1}^{UTr} ( {G}_{i} {F}_{u}^{( c )} ) + {σ}_{t}^{2}} \qquad ( 22 )$$

$${SINR}_{i}^{( r )} ( {F}^{( s )} , \{ {F}_{u}^{( c )} \} ) = \frac{η \vert {w}^{H} {g}_{i} {\vert}^{2} T r ( {G}_{i} {F}^{( s )} )}{{\sum }_{u = 1}^{U} η {\vert {w}^{H} {g}_{i} \vert}^{2} Tr ( {G}_{i} {F}_{u}^{( c )} ) + η {σ}_{t}^{2} {\vert {w}^{H} {g}_{i} \vert}^{2} + {σ}_{r}^{2}} \qquad ( 23 )$$

$$The SINR at the user is$$

$${SINR}_{i , u}^{( u )} ( {F}^{( s )} , \{ {F}_{u}^{( c )} \} ) = \frac{Tr ( {H}_{u} {F}_{u}^{( c )} )}{\begin{matrix}{\sum }_{l \neq u}^{U} Tr ( {H}_{u} {F}_{l}^{( c )} ) + η {\vert {h}_{i , u} \vert}^{2} ( Tr ( {G}_{i} {F}^{( s )} ) + \\ Tr ( {G}_{i} {F}_{u}^{( c )} ) + {σ}_{t}^{2} ) + {σ}_{u}^{2}\end{matrix}} . \qquad ( 24 )$$

Eqs. (21a)-(21g) can be rewritten as a mixed integer linear programming problem, which is given by

$${min}_{{F}^{( s )} , \{ {F}_{u}^{( c )} \} , y} - {\sum }_{i = 1}^{\vert 𝒢 \vert} {y}_{i} \qquad ( 25 a )$$

$$\begin{matrix}s . t . {SINR}_{i}^{( t )} ( {F}^{( s )} , \{ {F}_{u}^{( c )} \} ) \geq {γ}_{t} {y}_{i} , & ∀ i ∈ \{ 1 , … , \vert 𝒢 \vert \} ,\end{matrix} \qquad ( 25 b )$$

$$\begin{matrix}{SINR}_{i}^{( r )} ( {F}^{( s )} , \{ {F}_{u}^{( c )} \} ) \geq {γ}_{r} {y}_{i} , & ∀ i ∈ \{ 1 , … , \vert 𝒢 \vert \} ,\end{matrix} \qquad ( 25 c )$$

$$\begin{matrix}{SINR}_{i , u}^{( u )} ( {F}^{( s )} , \{ {F}_{u}^{( c )} \} ) \geq {γ}_{u} , & ∀ i ∈ \{ 1 , … , \vert 𝒢 \vert \} ,\end{matrix} \qquad ( 25 d )$$

$$∀ u ∈ \{ 1 , … , U \} , \qquad ( 25 e )$$

$$Tr ( {F}^{( s )} ) + {\sum }_{u = 1}^{U} Tr ( {F}_{u}^{( c )} ) \leq P \qquad ( 25 f )$$

$$\begin{matrix}{y}_{i} ∈ \{ 0 , 1 \} , & ∀ i ∈ \{ 1 , … , \vert 𝒢 \vert \} .\end{matrix} \qquad ( 25 g )$$

This problem can be solved using generalized Benders decomposition. The problem may be rewritten as a minimization problem, with the objective function being the negative of the original objective function to align with the default convention of generalized Benders decomposition. Generalized Benders decomposition decomposes a MINLP problem into two sub-problems: (i) a primal problem with continuous optimization variables and (ii) a master problem with discrete optimization variables. The two sub-problems are iteratively solved until guaranteed convergence.

In each iteration, the primal problem is defined by fixing the discrete variables, i.e., y^{(v)}, where v denotes the iteration counter. For the ease of notations, the constraints of Eqs. (25a)-(25g) can be integrated as

$$c ( {F}^{( s )} , \{ {F}_{u}^{( c )} \} , {y}^{( v )} ) = {[ \begin{matrix}\begin{matrix}{γ}_{t} {y}_{i}^{( v )} - {SINR}_{i}^{( t )} ( {F}^{( s )} , \{ {F}_{u}^{( c )} \} & ∀ i\end{matrix} \\ \begin{matrix}{γ}_{r} {y}_{i}^{( v )} - {SINR}_{i}^{( r )} ( {F}^{( s )} , \{ {F}_{u}^{( c )} \} ) & ∀ i\end{matrix} \\ \begin{matrix}{γ}_{u} - {SINR}_{i , u}^{( u )} ( {F}^{( s )} , \{ {F}_{u}^{( c )} \} ) & ∀ i , u\end{matrix} \\ Tr ( {F}^{( s )} ) + {\sum }_{u = 1}^{U} Tr ( {F}_{u}^{( c )} ) - P\end{matrix} ]}_{D \times 1} \qquad ( 26 )$$

where D=2| [symbol] |+U| [symbol] |+1 denotes the dimension. Since the optimization variables F^{(s)},

$$\{ {F}_{u}^{( c )} \}$$

are not in the objective function, slack variables α∈R^{D×} [symbol] , are introduced and the modified primal problem is:

$${min}_{{F}^{( s )} , \{ {F}_{u}^{( c )} \} , α} {\sum }_{i = 1}^{D} {α}_{i} \qquad ( 27 a )$$

$$s . t . c ( {F}^{( s )} , \{ {F}_{u}^{( c )} \} , {y}^{( v )} ) \leq α , \qquad ( 27 b )$$

$$\begin{matrix}{α}_{i} \geq 0 , & ∀ i ∈ \{ 1 , … , D \} .\end{matrix} \qquad ( 27 c )$$

In each iteration, the solution F^{(s)(v)},

$$\{ {F}_{u}^{( c ) ( v )} \}$$

is obtained, and the corresponding Lagrange multipliers λ^{(v)}∈ [symbol] . If the original primal problem is feasible, then

$${\sum }_{i = 1}^{D} {α}_{i} = 0.$$

[symbol]

and [symbol] are defined as the sets of iteration counters associated with feasible and infeasible primal problems. The Lagrange function is:

$$ξ ( {F}^{( s ) ( v )} , \{ {F}_{u}^{( c ) ( v )} \} , y , {λ}^{( v )} ) = \{ \begin{matrix}\begin{matrix}- {\sum }_{i = 1}^{\vert 𝒢 \vert} {y}_{i} + {λ}^{( v ) T} c ( {F}^{( s ) ( v )} , \{ {F}_{u}^{( c ) ( v )} \} , y ) , & v ∈ ℱ ,\end{matrix} \\ \begin{matrix}{λ}^{( v ) T} c ( {F}^{( s ) ( v )} , \{ {F}_{u}^{( c ) ( v )} \} , y ) , & v ∈ ℐℱ .\end{matrix}\end{matrix} \qquad ( 28 )$$

The master problem may be derived from the original problem in Eqs. (25a)-(25g) using non-linear convex duality theory. One way to address the issue of having an infinite number of constraints is to relax the master problem by dropping all but a few of the constraints and determine if the solution meets all the ignored constraints. The primal problem may be employed to determine the feasibility of the solution and iteratively add cutting planes as constraints, thereby reducing the feasible region. The relaxed master problem is:

$${min}_{y , ω} ω \qquad ( 29 a )$$

$$\begin{matrix}s . t . ω \geq ξ ( {F}^{( s ) ( v )} , \{ {F}_{u}^{( c ) ( v )} \} , y , {λ}^{( v )} ) , & ∀ v ∈ ℱ\end{matrix} , \qquad ( 29 b )$$

$$\begin{matrix}0 \geq ξ ( {F}^{( s ) ( v )} , \{ {F}_{u}^{( c ) ( v )} \} , y , {λ}^{( v )} ) , & ∀ v ∈ ℐℱ\end{matrix} , \qquad ( 29 c )$$

$$\begin{matrix}{y}_{i} ∈ \{ 0 , 1 \} , & ∀ i\end{matrix} , \qquad ( 29 d )$$

where ω is an auxiliary optimization variable. Eqs. (29b) and (29c) are the optimality and feasibility cuts, respectively.

For initialization, a feasible solution to the problem of Eqs. (25a)-(25g) is needed and an optimality cut may be derived from the primal problem, ensuring that the relaxed master problem in Eqs, (29a)-(29) does not become unbounded. y^{(v)}=0 may be chosen as the initial solution. In each iteration, the objective value of the relaxed master problem provides the lower bound (LBD) for the problem in Eqs. (25a)-(25g). The optimal solution y^{(v)} obtained from the relaxed master problem may be subsequently employed in the modified primal problem to check the feasibility. The feasible modified primal problem updates the upper bound (UBD) by keeping the best value to ensure the monotonically non-increasing. The iterative process concludes when UBD−LBD≤ϵ, where ϵ represents the predefined convergence tolerance. If the algorithm converges in K iterations, then the algorithm involves solving K semidefinite programming, i.e., primal problem, and K integer linear programming, i.e., relaxed master problem.

Taking the warehouse scenario as an example, the access point and the communication users, e.g., surveillance cameras, are placed at specific locations. The beamforming codebook may be pre-computed, and where the goods can be placed may be analyzed based on the coverage of the tag interrogation.

A codebook design method is outlined in the following code.

BEAMFORMING CODEBOOK DESIGN

| Initialization: [symbol] = Ø, Θₘᵢₙ = 0, Θₘₐₓ = Θₛₜₑₚ. | |
|---|---|
| 1 | while Θₘₐₓ ≤ 180 do |
| 2 | \| Construct the set of grid points [symbol] . |
| 3 | \| Initialize the generalized Benders decomposition: |
| | \| UBD = 0, LBD = 0, [symbol] = Ø, [symbol] = Ø, v = 0. |
| 4 | \| Select an initial feasible solution to (25): y^{(v)} = 0. |
| 5 | \| Solve the modified primal problem (27), and obtain |
| | $\vert optimal solution {F}^{( s ) ( v )} , \{ {F}_{u}^{( c ) ( v )} \} and the corresponding$ |
| | \| Lagrange multipliers λ^{(v)}. |
| 6 | $\vert Updated UBD = - {\sum }_{i = 1}^{\vert 𝒢 \vert} {y}_{i} and ℱ = ℱ ⋃ \{ v \} .$ |
| 7 | \| while UBD − LBD > [symbol] do |
| 8 | \| \| Set v = v + 1. |
| 9 | \| \| Solve the relaxed master problem (29), and obtain |
| | \| \| optimal solution y^{(v)} and ω^{(v)}. |
| 10 | \| \| Update LBD = ω^{(v)} |
| 11 | \| \| Solve the modified primal problem (27), and obtain |
| | $\vert \vert optimal solution {F}^{( s ) ( v )} , \{ {F}_{u}^{( c ) ( v )} \} and the corresponding$ |
| | \| \| Lagrange multipliers λ^{(v)}. |
| 12 | \| \| if (31) is feasible then |
| 13 | $\vert \vert \vert Updated UBD = min \{ UBD , - {y}_{i} \} .$ |
| 14 | \| \| \| Update [symbol] = [symbol] ∪ {v}. |
| 15 | \| \| else |
| 16 | \| \| \| Update [symbol] = [symbol] ∪ {v}. |
| 17 | \| \| end if |
| 18 | \| end while |
| 19 | $\vert Apply rank - 1 approximation to {F}^{( s ) ( v )} , {\{ {F}_{u}^{( c ) ( v )} \}}_{, and}$ |
| | $\vert Obtain , \{ \} .$ |
| 20 | $\vert Update ℱ = ℱ ⋃ \{ ( , \{ \} ) \}$ |
| 21 | \| Update Θₘᵢₙ = Θₘₐₓ, Θₘₐₓ = Θₘₐₓ + Θₛₜₑₚ. |
| 22 | end while |

Output: Beamforming codebook [symbol] .

The generalized Benders decomposition is applied to each sector. Each sub-area has an angle interval of Θₛₜₑₚ degrees, and the beamforming codebook comprises a total of

$$⌈ \frac{180}{{Θ}_{step}} ⌉$$

codewords. Semidefinite relaxation has been applied to Eqs. (25a)-(25g), and the obtained solutions from the generalized Benders decomposition, denoted by [symbol] , { [symbol] }, may be processed with an additional step. If [symbol] , { [symbol] } are rank-1, then

$$= {( )}^{H} , = {( )}^{H} ,$$

where [symbol] and { [symbol] } are the optimal solutions to Eqs. (25a)-(25g). If [symbol] , { [symbol] } are not rank-1, a rank-1 approximation approach may be used, e.g., the eigenvector with the largest eigenvalue. The eigen-decomposition of [symbol] may be expressed as

$$= {\sum }_{i = 1}^{r} {λ}_{i} {u}_{i} {u}_{i}^{H} \qquad ( 30 )$$

where r is the rank of [symbol] . λᵢ is the i^{th} largest eigenvalue, and uᵢ is the corresponding eigenvector. The normalized beamforming vector may be approximated with the dominant eigenvector u₁, and the beamforming vector [symbol] is

$$= \sqrt{Tr ( )} {u}_{1} \qquad ( 31 )$$

A simulation as described herein can be used to evaluate the performance of zero-forcing based method and joint beamforming optimization. In the simulation, the access point 105 is placed at the origin in Cartesian coordinates. The transmit and receive antennas of the access point 105 are uniform linear arrays along the y-axis, looking at the positive direction of the x-axis. The operating frequency is 2.4 GHz, and the spacing between antennas is half wavelength. The total transmit power of the access point is set to P=30 dBm. The number of communication user U=1, and communication SINR requirement is set to γᵤ=10 dB. For the channels, we adopt a line-of-sight channel model, and the variance of receive noise at the reader and the user is

$${σ}_{r}^{2} = {σ}_{u}^{2} = 10 {log}_{10} ( kTB ) + {N}_{f} dBm ,$$

where k is Boltzmann's constant, T=270 Kelvin, B=10 MHz, and N_{f}=7 dB is the noise figure. For the tag,

$${σ}_{t}^{2} = 10 {log}_{10} ( kTB ) dBm$$

since the tag does not have active components. The tag's and reader's sensitivity values are set to −25.5 dBm and −94 dBm, respectively. The backscatter-modulation efficiency of the tag is set to η=0.16 by assuming a given differential radar cross section and FMO encoding scheme. The modified primal problem and the relaxed master problem may be solved by, for example, but not limited to, MOSEK™ software via a CVX™ framework.

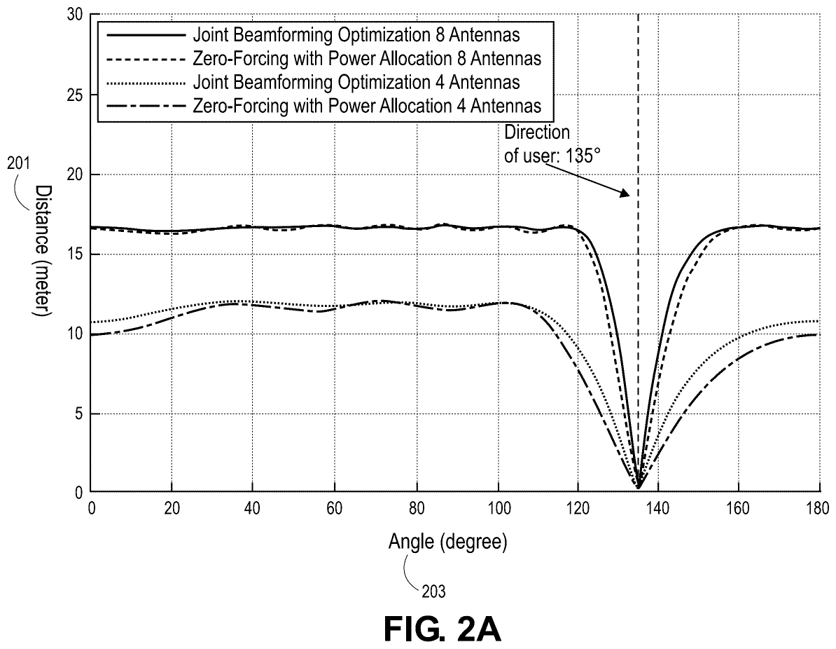

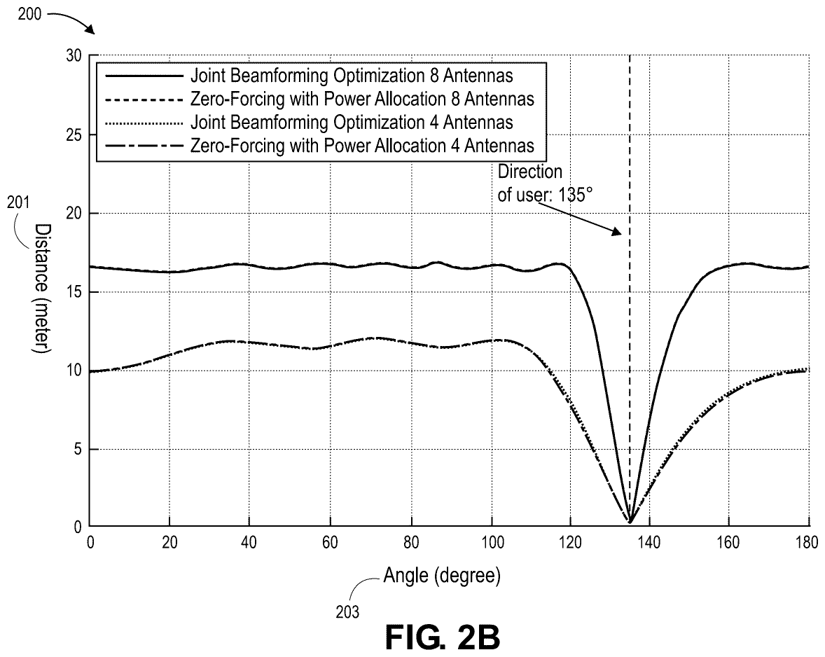

Referring now to FIGS. 2A and 2B, the detection distance 201 of tag directions 203 under two different communications device SINR specifications, i.e., low SINR (FIG. 2A) and high SINR (FIG. 2B), is shown. The communications device 101 is positioned at coordinates (5/\sqrt{2}, 5/\sqrt{2}), i.e., at 135° to the access point 105 (FIG. 1) and five meters away from the access point 105. The detection distance 201 increases with the growing number of antennas, based on the gain provided by beamforming. When the tag directions 203 of the RFID tag 103 (FIG. 1) and the communications device 101 (FIG. 1) are close, the detection distance 201 decreases due to high interference. The difference between the results under a low communications device SINR (FIG. 2A) and under a high communications device SINR (FIG. 2B) is based on the difference in tolerance of the communications device 101 for interference.

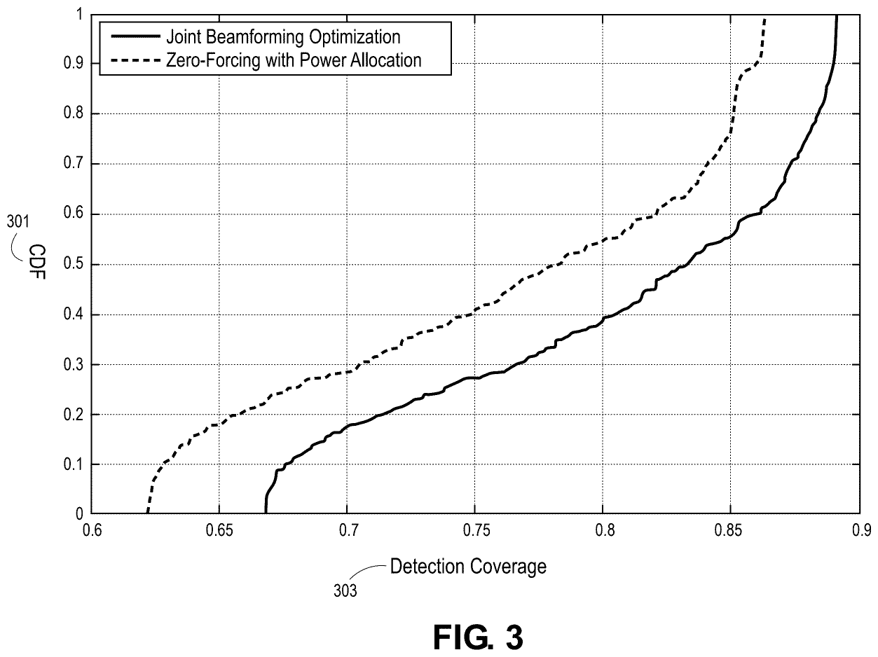

Referring now to FIG. 3, the CDF 301 of the detection coverage 303 of the RFID tag detection among different communications device positions under low communications device SINR is shown. For example, four hundred communications device positions are sampled, with x coordinates drawn from the range [0, 20] and y coordinates drawn from the range [−20, 20]. At the communications device position, the detection coverage 303 is computed as the average ratio of the detection distance 201 (FIGS. 2A/2B) to an upper bound across different angles 203 (FIGS. 2A/2B). The upper bound is defined as the detection distance 201 (FIGS. 2A/2B) of the RFID tag 103 (FIG. 1) when there is no communications device 101 (FIG. 1).

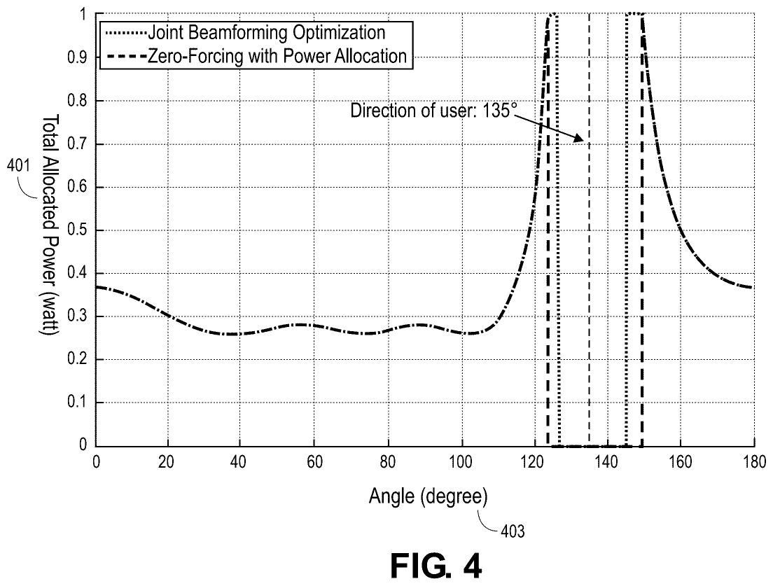

Referring now to FIG. 4, the total allocated power 401 with varying tag directions 403 is shown. For example, the communications device is positioned at coordinates (5/\sqrt{2}, 5/\sqrt{2}) and the distance between the tag and the access point is at six meters. When the RFID tag 103 (FIG. 1) is close to the communications device, the total allocated power 401 increases until it reaches a maximum limit of total transmit power because more transmit power is used to meet the communications device SINR and the tag detection, given higher interference.

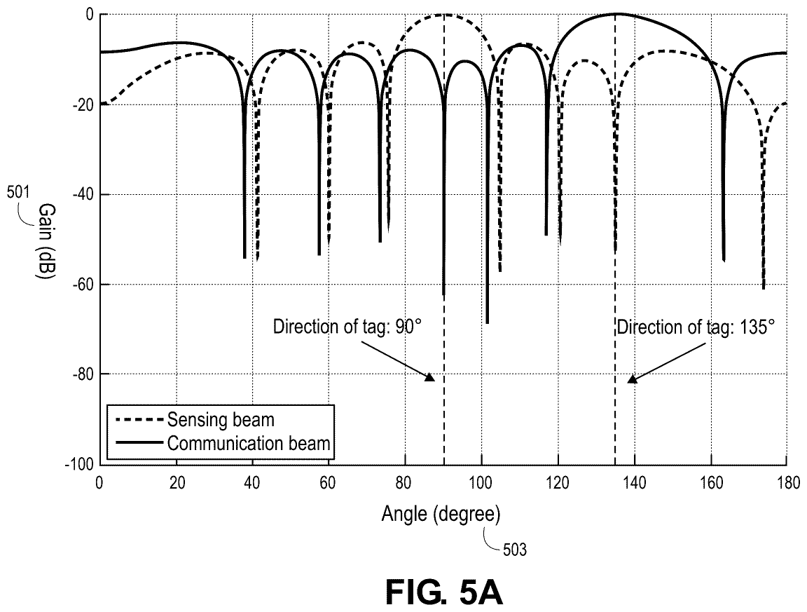

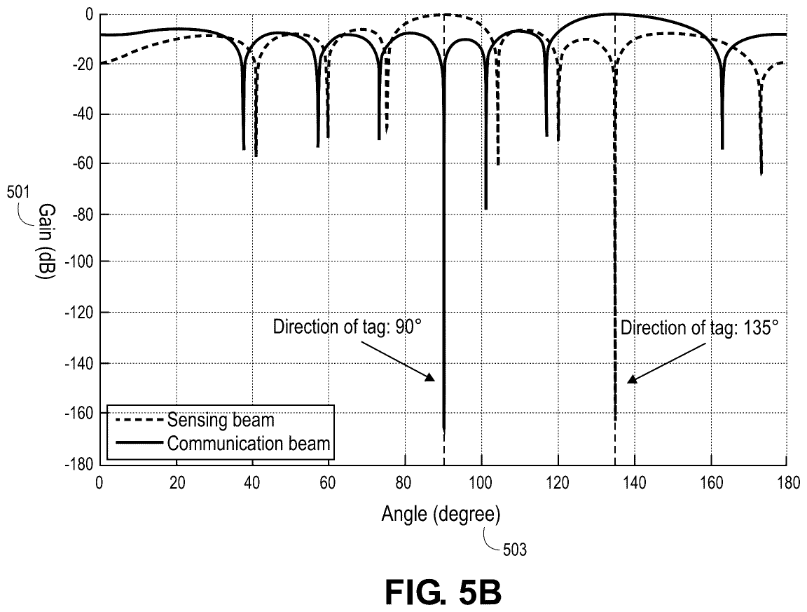

Referring now to FIGS. 5A and 5B, the beam patterns (gain 501 versus angle 503) are shown resulting from joint beamforming optimization and the zero-forcing based method, respectively. The main lobes of sensing and communication beams are steered toward the directions of the RFID tag 103 (FIG. 1) and the communications device 101 (FIG. 1), respectively. The sensing beam forms a null at the direction of the communications device 101 (FIG. 1) to eliminate the interference. A null is shaped at the direction of the RFID tag 103 (FIG. 1) by the communication beam.

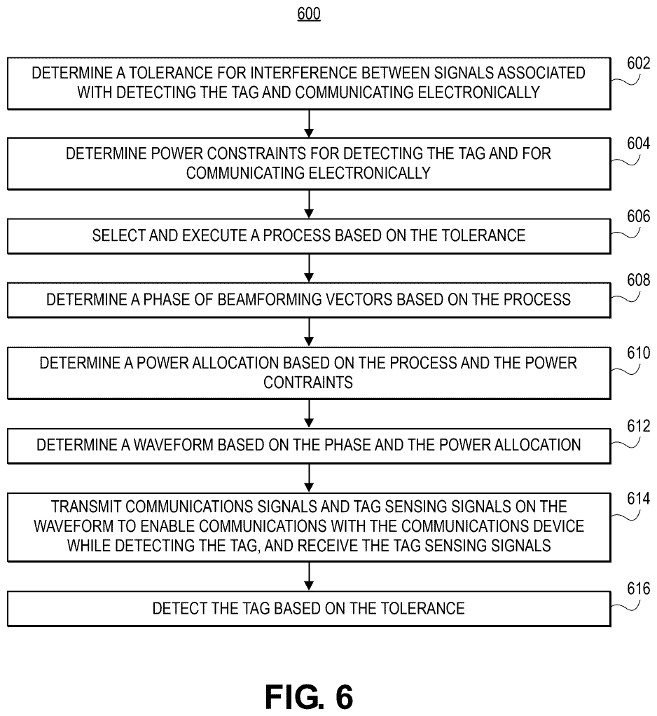

Referring now to FIG. 6, a method 600 for detecting and reading, by an access point, a tag while communicating electronically with a communications device is shown. The method 600 includes, but is not limited to including, determining 602 a tolerance for interference between signals associated with detecting the tag and communicating electronically, determining 604 power constraints for detecting the tag and for communicating electronically, selecting 606 and executing a process based on the tolerance, determining 608 a phase of beamforming vectors based on the process, determining 610 a power allocation based on the process and the power constraints, determining 612 a waveform based on the phase and the power allocation, transmitting 614 communications signals and tag sensing signals on the waveform to enable communications with the communications device while detecting the tag, and receiving the tag sensing signals, and detecting 616 the tag based on the tolerance.

While the present teachings have been illustrated with respect to one or more implementations, alterations and/or modifications can be made to the illustrated examples without departing from the spirit and scope of the appended claims. In addition, while a particular feature of the present teachings may have been disclosed with respect to one of several implementations, such feature may be combined with one or more other features of the other implementations as may be desired and advantageous for any given or particular function. As used herein, the terms “a”, “an”, and “the” may refer to one or more elements or parts of elements. As used herein, the terms “first” and “second” may refer to two different elements or parts of elements. As used herein, the term “at least one of A and B” with respect to a listing of items such as, for example, A and B, means A alone, B alone, or A and B. Those skilled in the art will recognize that these and other variations are possible. Furthermore, to the extent that the terms “including,” “includes,” “having,” “has,” “with,” or variants thereof are used in either the detailed description and the claims, such terms are intended to be inclusive in a manner similar to the term “comprising.” Further, in the discussion and claims herein, the term “about” indicates that the value listed may be somewhat altered, as long as the alteration does not result in nonconformance of the process or structure to the intended purpose described herein.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompasses by the following claims.

1. A method for an access point to detect and read a tag while communicating electronically with a communications device, the method comprising:
determining a tolerance for interference between signals associated with detecting the tag and communicating electronically;
determining power constraints for detecting the tag and for communicating electronically;
selecting and executing a process based on the tolerance;
determining a phase of beamforming vectors based on the process;
determining a power allocation based on the process and the power constraints;
determining a waveform based on the phase and the power allocation;
transmitting communications signals and tag sensing signals on the waveform, forming a communications and tag sensing waveform, to enable communications with the communications device while detecting the tag, and receiving the tag sensing signals; and
detecting the tag based on the tolerance.

2. The method of claim 1, wherein the access point comprises:
a transmitter antenna and a receiver antenna, and
separating a received signal from a transmitted signal.

3. The method of claim 1, wherein the tag and the communications device each comprise an antenna.

4. The method of claim 1, wherein the tag scatters signals by modulating the tag sensing waveform.

5. The method of claim 4, wherein the access point comprises using the scattered signals to determine a position.

6. The method of claim 4, wherein the communications device receives the signals from the access point and the scattered signals from the tag.

7. The method of claim 1, wherein the waveform transmitting communications signals and tag sensing signals satisfies the power constraints.

8. The method of claim 1, wherein a channel between the access point and the tag is reciprocal.

9. The method of claim 1, wherein a received signal signal-to-inference-plus-noise ratio (SINR) at the tag is based on allocated power for sensing and communications, and normalized sensing and communications beamforming vectors.

10. The method of claim 1, wherein a received SINR at the access point is based on allocated power for sensing and communications, and normalized sensing and communications beamforming vectors.

11. The method of claim 1, wherein a signal at the communications device is based on a first channel between the access point and the communications device, a second channel between the tag and the communications device, and noise at the communications device.

12. The method of claim 1, wherein a SINR of the communications device is based on a first channel between the access point and the communications device, a second channel between the tag and the access point, sensing and communications device beams, and allocated power.

13. The method of claim 1, wherein the sensing and communications device beams that detect the tag meet specifications (1) sum of squares of the sensing and communications device beams≤a total power, (2) a device SINR for the communications device≥a communications device specification, (3) a tag SINR for the tag≥a tag specification, and (4) an access point SINR for the access point≥an access point specification.

14. The method of claim 1, wherein the process comprises:
zero-forcing.

15. The method of claim 14, wherein the zero-forcing comprises:
determining the beamforming vectors based on a tag channel associated with a tag position of the tag and a communications device channel associated with a device position of the communications device;
normalizing the beamforming vectors to satisfy the power constraints; and
minimizing, using a convex solver, tag power and communications device power based on a tag SINR, a communications device SINR, an access point SINR, and a total power.

16. The method of claim 1, wherein the process comprises:
joint beamforming.

17. The method of claim 16, wherein the joint beamforming comprises:
minimizing a sum of sensing beam and communications device beams based on a communications device SINR, a tag SINR, a receiver SINR transformed into second-order cone constraints, a sum of squares of sensing and communications device beams, and a total power.

18. The method of claim 1, wherein the tag comprises:
one of a passive tag or an active tag.

19. A computer system for an access point to detect and read a tag while communicating electronically with a communications device, the computer system comprising:
a hardware processor;
a non-volatile storage medium storing instructions that when executed by the hardware processor perform operations comprising:
determining a tolerance for interference between signals associated with detecting the tag and communicating electronically;
determining power constraints for detecting the tag and for communicating electronically;
selecting and executing a process based on the tolerance;
determining a phase of beamforming vectors based on the process;
determining a power allocation based on the process and the power constraints;
determining a waveform based on the phase and the power allocation;
transmitting communications signals and tag sensing signals on the waveform to enable communications with the communications device while detecting the tag, and receiving the tag sensing signals; and
detecting the tag based on the tolerance.

20. A computer program product for an access point to detect and read a tag while communicating electronically with a communications device, the computer program product comprising a computer readable storage medium having program instructions embodied therewith, the program instructions executable by a computing device to cause the computing device to perform operations comprising:
determining a tolerance for interference between signals associated with detecting the tag and communicating electronically;
determining power constraints for detecting the tag and for communicating electronically;
selecting and executing a process based on the tolerance;
determining a phase of beamforming vectors based on the process;
determining a power allocation based on the process and the power constraints;
determining a waveform based on the phase and the power allocation;
transmitting communications signals and tag sensing signals on the waveform to enable communications with the communications device while detecting the tag, and receiving the tag sensing signals; and
detecting the tag based on the tolerance.
